(19) United States
(12) Patent Application Publication
(10) Pub. No.: US 2010/0018099 A1
(43) Pub. Date: Jan. 28, 2010

(54) Consumer product recognition system

(76) Inventors: Julie Karen Lang, Wausau, WI (US); Heather Gayle Lang, madison, WI (US); Paul James Lang, Madison, WI (US)

Correspondence Address: Intellectual Property Dept.;Dewitt Ross & Stevens SC, 2 East Mifflin Street, Suite 600, Madison, WI, 53703-2865, US

(21) Appl. No.: 12/220,519

(22) Filed: Jul. 25, 2008

(51) Int. Cl. G09F 3/10; G09F 3/02

(52) U.S. Cl. 40/638; 40/299.01; 40/672

(57) ABSTRACT

A method and system which promote consumer loyalty and simplify specific product recognition. A label or product detachment designed with the option of a quick release, non-drying, adhesive backing facilitating repeated consumer use. Adaptable to the large variety of consumer product lines and their extreme size variations, it is sized for convenience and adapted to bear and convey specific product information in a clear and concise manner on several levels of human recognition. This detachment has flexible design options such as, but not limited to, the ability to be transparent or opaque, have colored or non colored indicia or surfaces, single or multiple layer attributes along with the ability to take on simple or novel shapes. Considerations taken in regards to the many sectors of our consumer populations, those that are illiterate, foreign speaking, disabled, allergic, medically restricted, the young and old alike, resulted in a universal solution to obtain product loyalty and recognition.

### BACKGROUND

1. Field of Invention

The present invention relates to printed matter, in particular a method and system used in conjunction with that of a small, special in design, product label or detachment that assists manufacturers to obtain and maintain consumers' product buying loyalties and simplify specific future product recognition.

2. Prior Art

The continued efforts of the merchandising industry to simplify consumer product recognition while attempting to obtain brand and product buying loyalties take on numerous forms. Look at the cute Pillsbury Dough Boy®, the little BIC® man, and Elmer's® famous cow upon their glue. In an attempt to maintain or gain a greater share of the market, manufacturers continually introduce new products to suit more specific needs, be more environmentally friendly, or to simplify everyday living. While this constant influx of new and/or improved products is beneficial to consumers, it also increases consumer confusion and frustration. Valuable time spent by consumers in an attempt to recall, locate, and identify a specific product increases with the increased variety of products made available to them. Product manufacturers are not alone in this struggle to simplify specific product identification and consumer purchasing. Retailers also search for a solution to this endeavor. Self-check-out systems have been placed in stores to speed up or simplify the consumer check out process. A nation wide grocery chain is working on a concept that would offer a consumer the ability to scan and bag desired purchases upon removal from shelves. Menards® stores have implemented a method to simplify and increase the efficiency of merchandise returns. Many merchandise returns result from consumer inability to remember or recognize specific products sought. Another concept was recently televised where a consumer could utilize an electronic device attached to a shopping cart. This device is intended to aid the consumer in the ability to locate products within a retail establishment. The demand to obtain consumer loyalties, accommodate consumer needs, and simplify specific product recognition and consumer purchasing is great.

U.S. Pat. No. 6,113,148 to Koranda (2000) discloses a shopping reminder system that comprises a removable, self adhesive, indicator element as a miniature image of the product label to which it is attached. The simplicity of Koranda's invention is attractive. However, this simplicity causes the invention to fall short of the ability to accommodate the vast and various needs of product manufacturers. The need for invention design flexibility and numerous features capable to accommodate the multitude and variety of available products, the variations incurred with product size and methods of packaging, the wide array of similar products within a line, has not been fulfilled to the extent necessary to accommodate producers' needs. A simple test that illustrates some of the inefficiencies within U.S. Pat. No. 6,113,148 can be accomplished by viewing a product advertisement found in a newspaper. The need to be clear, concise and inclusive of all information for future and specific product re-identification, while maintaining an attachment relatively small in size, is lost.

U.S. Pat. No. 6,898,881 to Morrison (2005) discloses a removable product quantity indicator tab with reusable adhesive qualities. The scope of the Morrison invention is narrow. It is a discrete shopping reminder system that relates to products where usage or depletion levels are visually hidden from the consumer. More specifically, the Morrison invention applies to web wound products or containers that hold a multitude of the same product such as a box of facial tissue. This indicator tab is intended to warn a consumer of a product that nears total depletion and the need, if desired, to replenish the product. The narrow scope of the Morrison patent, along with the design features offered, continues to lack in the versatility and options required for a consumer product identification system with the ability to accommodate the differentiating needs of product manufactures.

U.S. Pat. No. 7,195,689 to Adams, et al. (2007), relates to the manufacture and use of double-sided labels that include printed information on their front and back sides. More specifically, labels attached to a product in a permanent manner with design attributes that enable a portion of the label to be detached for consumer usage. Although U.S. Pat. No. 7,195,689 stakes claim to methods of consumer use, none of the methods stated address that of a “Consumer Product Recognition System”.

None of the above inventions and patents taken either singly or in combination are seen to describe the present invention as claimed.

### SUMMARY OF THE INVENTION

The current disclosure addresses a resolution to consumer confusion and frustration while providing product manufacturers a new venue in which to obtain and maintain consumers' product buying loyalties. It also simplifies consumer purchasing at the retail level. This is accomplished through the creation of label-type stickers or an easily detachable section of a product's current label or its packaging. For the purposes of this invention these creations will be referred to as “product identifiers” or simply an “identifier”. Product identifiers comprise concise information in a compact form having multiple layers of indicia and information useful to the consumer. A product identifier would not only be capable to hold information for future product recognition purposes, but capable to sell product benefits. Approximately the size of a large United States postage stamp, it has the ability to take on unique or novel shapes. Designed to be easily removed, or detached from a product or its packaging, a product identifier has the ability to be posted on a shopping list, refrigerator door, computer screen, or other such receptacle.

From the brief and general descriptions above a number of objectives and advantages become evident.

The object to provide a specific product identifying system that does not require special talent or a special device to use has been met.

Instant and immediate consumer acceptance, usage, and gratification are of great advantage.

It is an advantage to have invention options and allowances made for easy removal of a consumer product identifier, along with informational instructions to do so.

It is another advantage to use one future product identifier numerous times.

Consumer usage of a product identifier offers an inexpensive method to reinforce and ensure consumer product loyalty.

It is inevitable that these product identifiers will be posted in locations such as the home, office, work place, or car. This results in product and brand advertising at no additional cost to the manufacturer.

A consumer's repetitive handling and use of a product identifier will inevitably draw interest to other products within that brand, which illustrates yet another advantage to product manufacturers.

The current disclosure decreases consumer time spent shopping for desired or necessary purchases and therefore increases the amount of leisure shop time. This results in additional product sales, a benefit at both the manufacturing and retail levels.

Decreasing consumer confusion and frustration results in a decreased need of customer service employees.

The object to decrease merchandise returns due to incorrect purchases is another advantage obtained.

A product identifier designed with the inclusion of a machine-readable product code such as a Universal Product Code, or a bar code, can be removed from large and cumbersome products for scanning purposes, which accomplishes the objective to simplify the purchase and check out process of such items.

It is advantageous to provide flexible design attributes, which have several layers of meaning to the consumer, to reinforce both brand and product loyalty. The object to enable the inclusion of safety precautions or allergy warnings, school support programs, recipes, and sale enticements such as redeemable manufacturer coupons or game tokens within a product identifier has been met through various design options offered.

It is yet another advantage to have the option to reinforce product recognition through an embodiment that has the ability to take on various product or product related shapes.

The flexibility of a product identifier to be either transparent or opaque is highly desired to accommodate the varying needs of product manufactures.

The object to offer an embodiment capable of functioning in a dual manner, a product label and a future consumer product identifier, has been met and made available.

The combination of the transparent feature with that of the dual purpose option stated above is especially beneficial for those products small in size. To present a simple example (not illustrated in the drawings), a common disposable ink pen has an approximate circumference of one inch (approximately 2½ cm). This offers adequate area to place a future product identifier upon it. The transparent feature allows a consumer to view both the level and color of ink remaining.

For those manufacturers that prefer, or for products better suited to, the option of a product identifier being a portion of a product's already existing label has been made available.

A product and brand loyalty system with capabilities to be designed in a fold out or accordion manner that utilizes limited space is advantageous. Also considered with regard, is the product's pre-existing area located directly behind the placement of a product identifier. This pre-existing area is available for numerous uses. One such use may be that of a manufacturer's desire to show gratification for consumer loyalty.

The ability to reach foreign language speaking consumer sectors through the inclusion of a secondary language(s) upon an embodiment is another objective met.

Another benefit derived form the current disclosure is a product purchasing system that simplifies and aids those who attempt to shop for others.

Enticing consumers into retail establishments is an on going goal for manufacturers and retailers alike. This physical presence often results in additional sales not otherwise obtained. More difficult to achieve are the sales and revenues gained through those truly disabled and homebound consumer sectors. While the current disclosure simplifies the purchasing process for those friends and family members willing to assist the disabled and homebound, an option is also available for those retailers interested to offer further assistance with this sector of our consumer population. Up until now the ability to easily compile a complete, accurate, and a detailed shopping list to fax, send, or deliver to a retail establishment for fulfillment of one's needs has been nonexistent or clumsy at best. This can now be accomplished in a convenient and efficient manner.

For numerous reasons the usage of braille in the merchandising industry is uncommon. The current disclosure offers the use of braille to accommodate the vision impaired. Whether or not a product manufacturer utilizes the braille option, those consumers with vision impairments will come to understand consumer product identifiers along with their intent and the benefits derived from them.

It is desirable to have “A Consumer Product Recognition System” that has all the benefits and none of the drawbacks of the related art.

Although the descriptions above contain many specifics, these should not be construed as limits to the scope of an embodiment, but merely to provide illustrations of some of the presently preferred embodiments.

These advantages and other objects of the present invention will become more readily apparent upon further review of the following specification and drawings.

### DESCRIPTION OF THE DRAWINGS

A complete understanding of the present invention may be obtained by reference to the accompanying drawings, when considered in conjunction with the subsequent descriptions in which:

### DRAWINGS—FIGURES

In the drawings, related figures have the same number but different alphabetic suffixes.

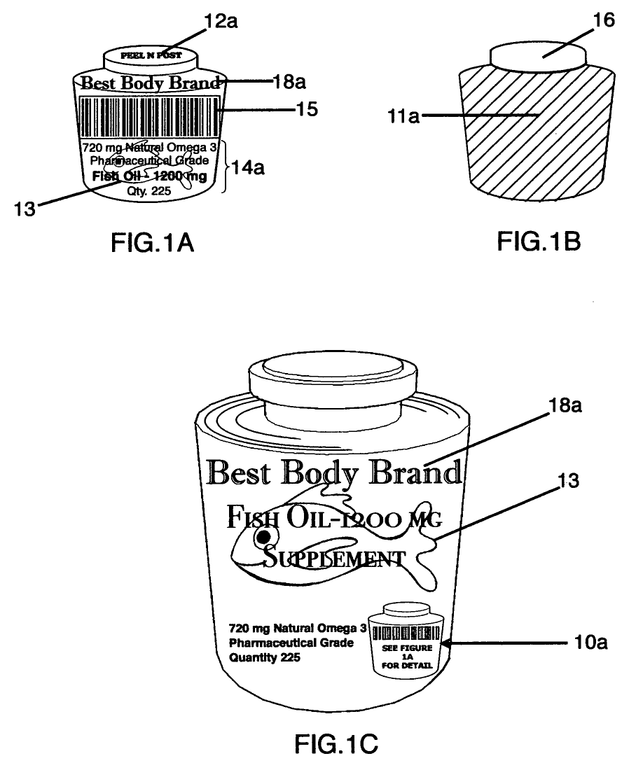

FIG. 1A is a perspective front view of a product identifier that illustrates the ability of an embodiment to take on that of a unique or novel shape.

FIG. 1B is a perspective back view of the product identifier displayed in FIG. 1A.

FIG. 1C is an environmental front view of the corresponding consumer product that displays the placement of the product identifier illustrated in FIGS. 1A&B in accordance with one embodiment.

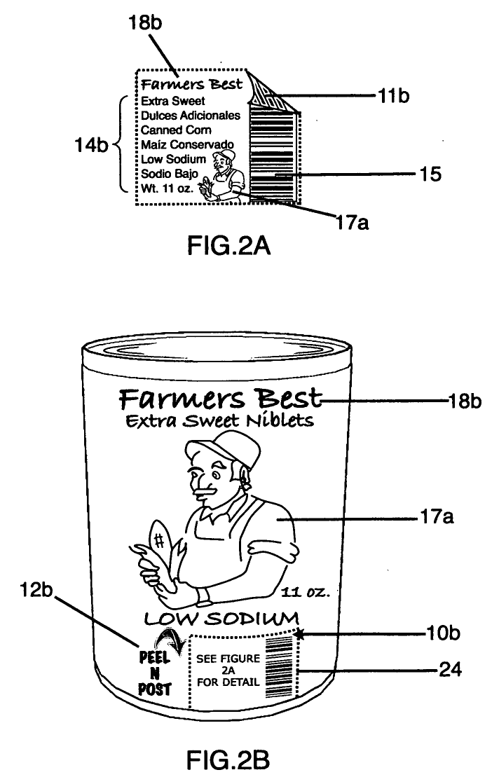

FIG. 2A is a perspective front view of a product identifier that was previously a portion of an already existing product label.

FIG. 2B is an environmental front view of the corresponding consumer product that illustrates the product identifier displayed in FIG. 2A as a perforated portion of the product's already existing label in accordance with another embodiment.

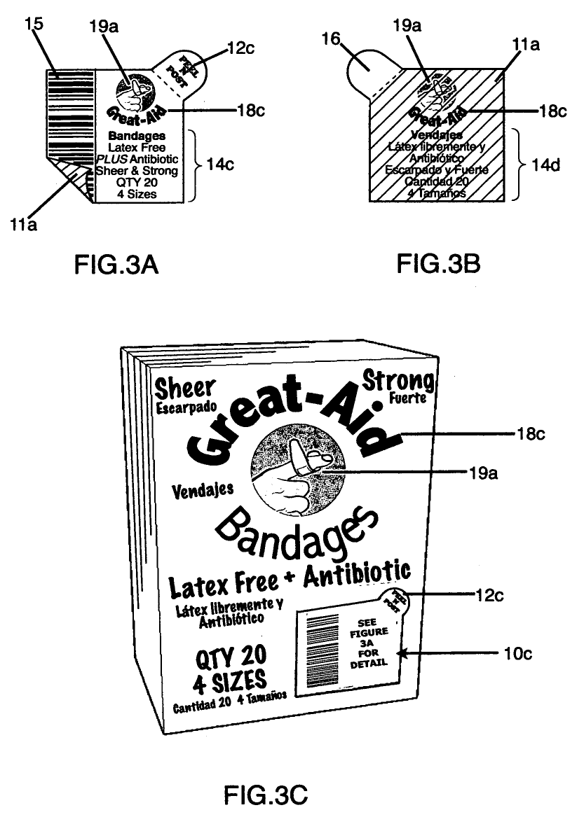

FIG. 3A is a perspective front view of yet another embodiment designed with an extended or protruding tab like feature for additional simplicity and ease of removal.

FIG. 3B is a perspective back view of the embodiment displayed in FIG. 3A and illustrates the option of placing additional indicia and information upon an identifier's back side prior to the application of adhesive.

FIG. 3C is an environmental front view of the corresponding consumer product that displays the placement of the product identifier illustrated in FIGS. 3A&B.

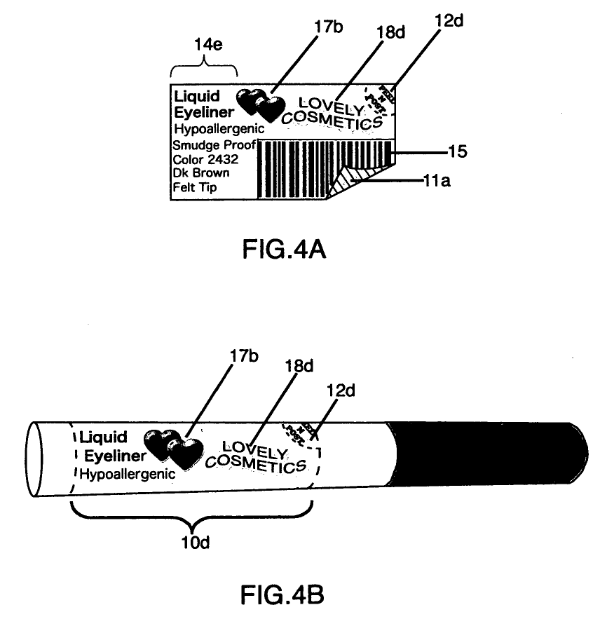

FIG. 4A is a perspective front view of a partially transparent product identifier designed to perform a dual purpose that of a product label along with the ability to be a future product identifier.

FIG. 4B is an environmental front view of the corresponding consumer product that displays the placement of the product identifier illustrated in FIG. 4A essentially comprising the product label in accordance with another embodiment.

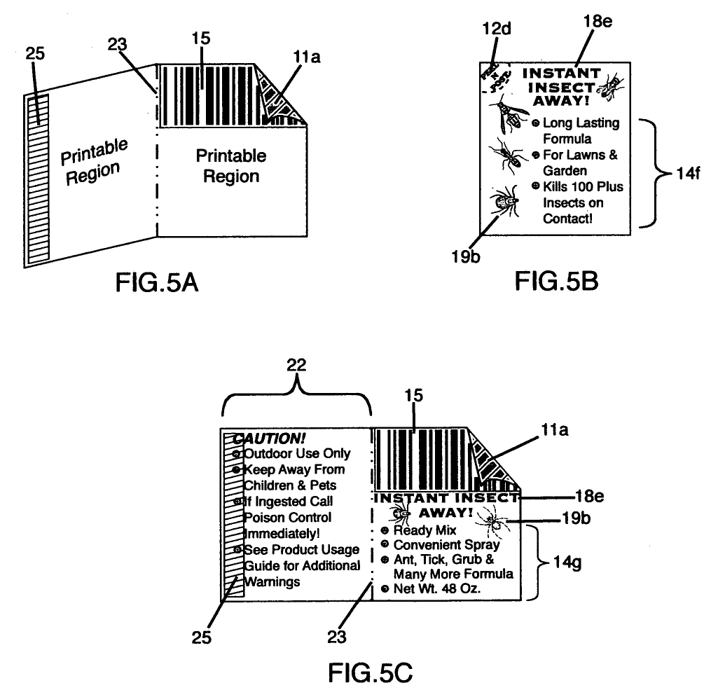

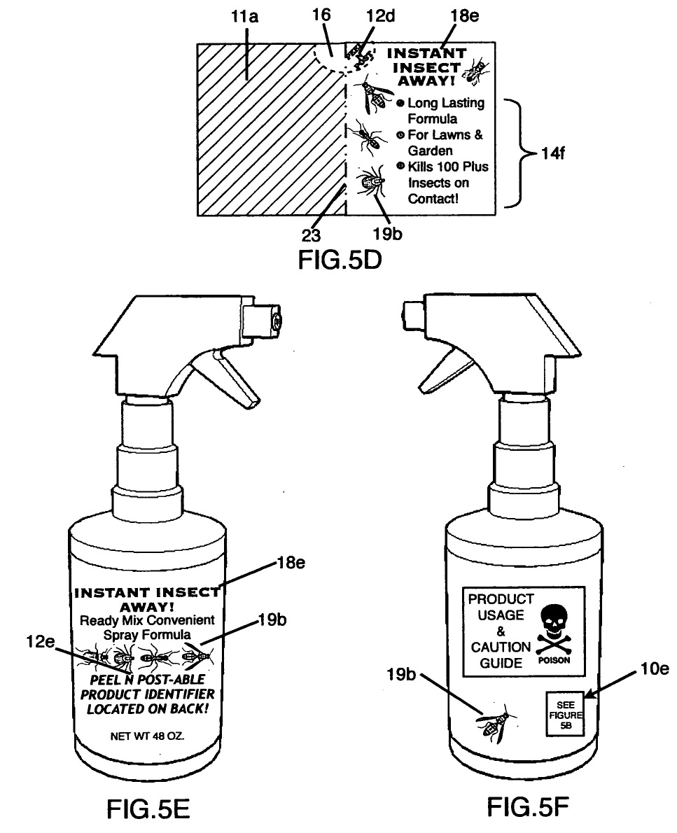

FIG. 5A is a plan view of a further embodiment designed in a fold out manner with the ability to illustrate indicia and information on three of the four panels created.

FIG. 5B is a perspective front view of a fold out style product identifier (as illustrated in FIG. 5A) in its fully closed configuration.

FIG. 5C is a perspective view of the mid or inner panels created for the product identifier displayed in FIG. 5B. FIG. 5C illustrates FIG. 5B in a fully open configuration.

FIG. 5D is a perspective view of the outer section or panels created for the product identifier shown in FIG. 5B. FIG. 5D illustrates FIG. 5B in a fully open configuration.

FIG. 5E is an environmental front view of the corresponding consumer product for the identifier displayed in FIGS. 5B,C&D.

FIG. 5F is an environmental back view of the corresponding consumer product (FIG. 5E) that displays the placement of the product identifier illustrated in FIGS. 5B,C&D.

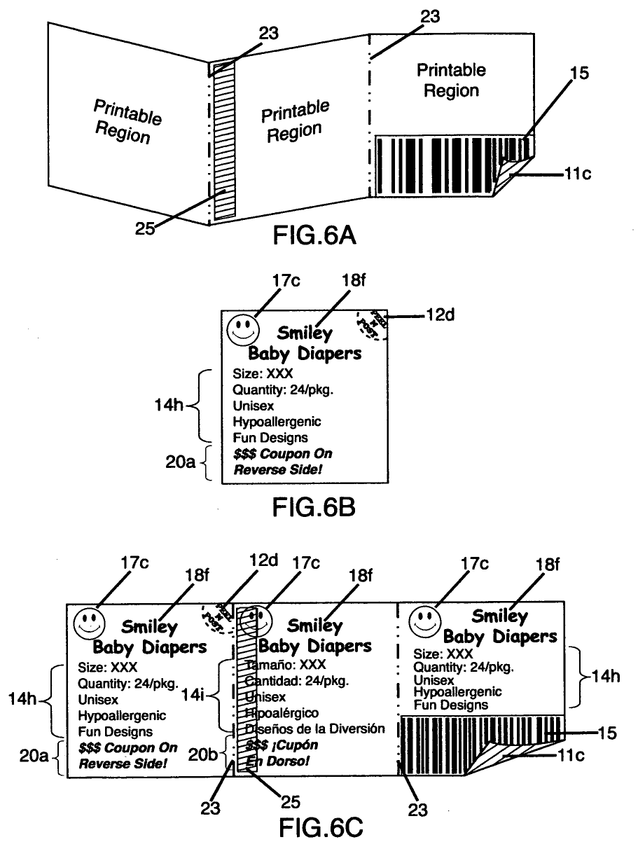

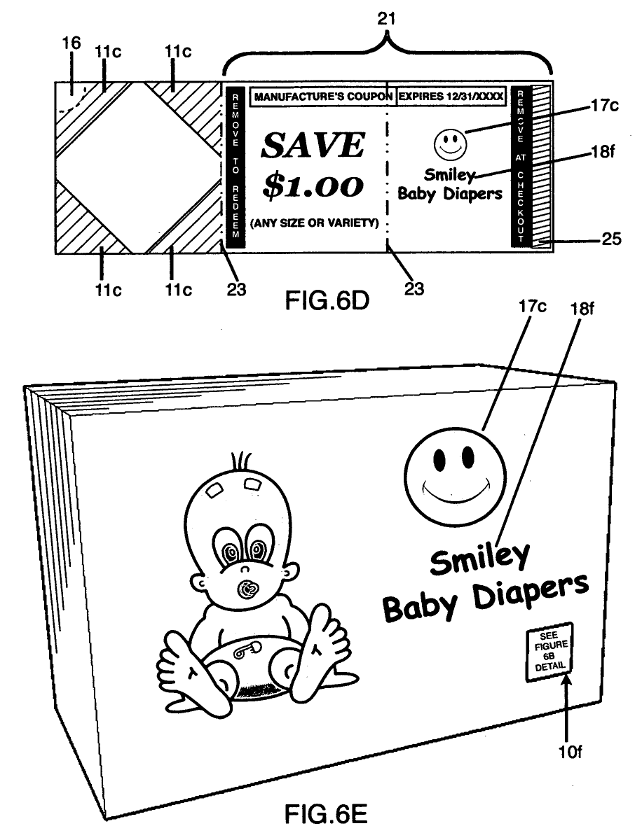

FIG. 6A is a plan view of yet another example embodiment having that of an accordion or plurality fold out design. This example embodiment illustrates the ability to place indica and information upon five of the six panels created to maintain a product identifier relatively small in size.

FIG. 6B is a perspective front view of an accordion style product identifier (as illustrated in FIG. 6A) in its fully closed configuration.

FIG. 6C is a perspective view of the front and mid sectional panels of the product identifier displayed in FIG. 6B and illustrates the product identifier in its fully open and extended position.

FIG. 6D is a perspective view of the back and mid sectional panels of the product identifier displayed in FIG. 6B and again illustrates the product identifier in a fully open and extended position.

FIG. 6E is an environmental front view of the corresponding consumer product that displays the placement of the product identifier illustrated in FIGS. 6B,C&D.

With the exception of the simulated consumer product drawings, all other drawings are illustrated in functional scale and size ranges. The figures that illustrate single panel embodiments, or embodiments in their fully folded and compact position, range in size from approximately 1&¼ to 2 inches (3 to 5 cm) wide by approximately 1 to 1&¾ inches (2½ to 4½ cm) high. There are no restrictions or specific guidelines to the size of an actual embodiment. However, to view these example embodiments in this manner better illustrates the ability to present key product identifying information in addition to a wide array of supplemental enclosures in a clear and concise manner within a relatively small area. This area is receptive to additional size reduction while continuing to maintain clear and concise properties. The introduction of color enhances an embodiment, which contributes to additional clarity. Other plan and section views of the embodiments, considerable mechanical detail of devices for the production of labels, and the application of print and adhesive have been omitted. Such details are not considered necessary for one skilled in the art to obtain a full and complete understanding of the invention disclosed herein. It should also be understood that the present invention is not limited to the embodiments illustrated.

### DRAWINGS—REFERENCE NUMERALS

The present invention is of a type that incorporates the use of a detailed method and system with that of a specially designed label or product detachment Therefore, a listing of the various components along with a definition or description of their intent and/or methods of use follows to create additional ease to understand the current disclosure. No limitations should be understood therefrom, as modifications will be obvious to one skilled in the art.

In the drawings, reference is made to accompanying drawings wherein like components have like reference numerals, and components similar in nature have like reference numerals but different alphabetic suffixes.

Reference Numeral 10 indicates an example placement location of an embodiment upon a simulated consumer product. Due to individual manufacturer preferences, along with differentiating product needs the current disclosure offers no specific guidelines for the placement of a product identifier upon its corresponding product. Numerous situations arise that require placement flexibility. Many products on our market today are sold in packaging that is removed and discarded prior to actual product usage. For those identifiers placed in low or non-visible locations during the product marketing or pre-consumer purchase stages, it is suggested that considerations be made to inform consumers in another manner of the inclusion of a product identifier. The incorporation of a simple statement on the front of the product or its packaging that notify consumers of the hidden enclosure would be of significant value until which time these identifiers come to be expected.

Reference Numeral 11 refers to an area in which an adhesive substance has been applied to an embodiment. In most cases illustrated, this adhesive application is intended to serve that of a dual purpose. It is intended to affix a product identifier to its corresponding product and offer reusable qualities to the consumer. That being the case, a non-drying, quick release type of adhesive that allows both non-damaging removal of an embodiment along with qualities that enable the consumer to re-apply an identifier numerous times would be best selected. For consumer products that require refrigeration, frozen goods, or products that are exposed or stored in a humid environment, adhesives that have the additional quality of moisture resistance need to be considered. A complete adhesive backing is not required. The option to place adhesive upon four corners, or in the shape of an “X” (not shown) would suffice. There are numerous types of adhesive and methods of application in addition to numerous methods in which to include or affix a product identifier to that of a consumer product. None are intended to be eliminated or discouraged. Even a product identifier without adhesive qualities would be better then no identifier at all.

Reference Numeral 12 illustrates embodiment removal and use instructions or the instructive insignia, “Peel N Post”. These instructions, illustrated in several different manners, are important as an aid to create consumer awareness of the inclusion of a product identifier along with encouraging its use.

Reference Numeral 13 illustrates the option of placing a product trademark, logo, or related image in the form of a water mark or a faded (ghost like) image as a background to, or behind, other communicating information. This option was created as an aid to maintain an embodiment relatively small in size.

Reference Numeral 14 refers to key product related or identifying information. The desired goal in this area is to select and present enough key product information in a clear and concise manner to enable a consumer to easily recognize, at a future point in time, the product for which the identifier was intended.

Reference Numeral 15 refers to the inclusion and placement of a machine-readable product code upon an embodiment. For illustration purposes, allowances have been made in the drawings for the inclusion of a Universal Product Bar Code. The display of an embodiment in this manner is not intended to exclude the use or inclusion of other current or future machine-readable product codes. A Universal Product Bar Code is commonly displayed upon a white back ground and has a 1 to 1&½ inch (2&½ to 4 cm) width requirement that must be considered when incorporated into a product identifier. The height is flexible and can be altered or changed with no appreciative loss of function. This height flexibility is an advantage to maintain a product identifier relatively small in size. Not required for the success of the current disclosure, there are many advantages to be gained through the inclusion of a machine-readable product code upon a product identifier.

Reference Numeral 16 indicates the avoidance of adhesive in the area located directly behind the “Peel N Post” instructive insignia (Reference Numeral 12). There are many methods in which to remove or simplify the removal of a product identifier from the product to which it corresponds. The avoidance of adhesive in that area located directly behind removal instructions illustrates only one such method to do so.

Reference Numeral 17 illustrates the inclusion of a product logo or trademark upon an embodiment. Manufacturers and consumers strongly associate a product logo or trademark with that of a specific product, product line or brand. Such an inclusion not only aids the majority of the consumer populations, but is an even greater benefit to the foreign and illiterate consumer sectors.

Reference Numeral 18 illustrates the inclusion of the product name and/or brand upon an embodiment. Font style, color, and method of display seen upon a product's current label or packaging would be best duplicated when placed upon the product's identifier.

Reference Numeral 19 refers to a product related image or use related image incorporated into an embodiment as a visual aid for future product identification purposes. Once again, one can see the benefits such an inclusion offers not only to the majority of the consumer populations but also the foreign and illiterate sectors.

Reference Numeral 20 illustrates the option to place an informational statement or message to the consumer that notifies them of an additional enclosure(s) within or upon the reverse side of an embodiment.

Reference Numeral 21 displays the option and ability to incorporate a consumer enticement within an embodiment. The enticement used for illustration purposes is that of a manufacturer's redeemable product coupon. By illustrating an enticement in this manner, it is not intended to limit or restrict the type or form of enticement included or the need to utilize this area for that of an enticement.

Reference Numeral 22 illustrates the ability to reenforce or include product warnings or precautions within an embodiment. These warnings may take on many forms: contains shell fish, latex, small parts not recommended for ages three and younger, and fatal if ingested state just a few. Again, by illustrating an area within an embodiment for a suggested use, the intent is not to limit the use or type of enclosure placed within an embodiment.

Reference Numeral 23 indicates the location of a fold(s) within the multi panel embodiments illustrated. It is at a fold location that the addition of perforation (not illustrated) may be considered. The addition of perforation to an embodiment with more then one panel offers consumers the ability to detach, in a non-damaging manner, and use or discard those sections of an embodiment that are or are not of interest to them. This simplifies a somewhat complicated embodiment. There are numerous methods other than those illustrated in the current disclosure, in which to fold, reduce, or keep an embodiment relatively simple and small in size. None are intended to be eliminated or discouraged.

Reference Numeral 24 refers to the option of using perforation to simplify the removal of an embodiment that has been created as a portion of a product's already existing label.

Reference Numeral 25, closure adhesive, indicates the use and location of an adhesive substance to temporarily maintain a bi or multi panel embodiment in its fully closed and compact position until which time a consumer would like to view the embodiment in its entirety. This example of an adhesive application is only one method in which to maintain the temporary closure of an embodiment. The use of an additional sticker (not shown), either basic or novel in design, or a plastic overlay (not shown) are only two other methods that could be implemented to serve the purpose of temporary closure.

### DETAILED DESCRIPTION OF THE PREFERRED EMBODIMENTS

The material composite of a product identifier is largely determined by the type of consumer product the identifier is being placed upon, the pre-existing product label or the packaging it is being incorporated into, or one's preference. In circumstances where it is undesirable for a product or its contents to be obscured or located behind its product identifier, a composite that creates a thin, flexible, and transparent embodiment may be used. It is assumed that an identifier placed upon a product intended for human or animal consumption is of a material composite safe for such. It is also recommended that considerations be made that upon consumer removal and repeated use of a product identifier a material composite that discourages distortion or damaged is used. Respecting the value of a product's current label space and the desire to place an identifier upon a consumer shopping list or some such transportable carry along instrument encourages an identifier of relatively small proportions. Therefore, efforts to present product identifying indicia and information in an all inclusive, yet condensed, method which maintains clear and concise properties is strongly recommended. The current disclosure offers numerous options and illustrations that enable obtainment of that goal in a simple and efficient manner.

FIGS. 1A,B & C

Referring now to FIG. 1A, the product identifier illustrated is in the shape of the product to which it is associated, a pill bottle (FIG. 1C). Thus, displaying the option of a product identifier to take on unique or product related shapes. An identifier placed upon a box of canine treats may take on the shape of a bone (not shown), and so on. The removal and use instructions, or the instructive insignia 12a, “Peel N Post”, can be seen placed within the cap portion of the pill bottle-shaped identifier or at the top of the identifier. Best Body Brand 18a, the simulated product name, follows and would be best displayed in a manner identical to that shown upon its corresponding consumer product (FIG. 1C). Note the inclusion of a machine readable product code 15. Key product identifying information 14a is intended to offer a consumer very exact and specific product identifying information. Thus creating future consumer ability to easily recognize, and select for repurchase, the specific product for which the identifier is intended. In order to maintain a product identifier that is clear, concise, and relatively small in size, there will be a need to exercise caution to ensure selecting a sufficient amount of specific product identifying information, yet not become too obtrusive. In FIG. 1A, an identifier for that of a dietary supplement, the key product identifying information 14a appears as follows. The type of supplement is of importance, “Fish Oil”. “1200 mg” tablets along with the information that “720 mg (are) Natural Omega 3” further identifies the specific product. The inclusion of the statement “Pharmaceutical Grade” also aids in future product identification along with presenting information that may be viewed as a sales enticement. The optional inclusion of a product's quantity, “Qty. 225” illustrated, is controversial and effected by numerous factors. Should a product be of the type that offers a variety of different quantity options available for purchase, one may wish to state the various options available such as: Qty. 50, 100, or 150 pieces or 100, 150, or 200 fluid ounces (2.95, 4.44, or 5.91 liters), and so on. A product manufacturer may prefer the sale of one quantity over that of another for reasons such as packaging costs or profits to be made. Consumers have a variety of reasons for selecting specific quantities: storage space, cost, or the desire to avoid product waste, name only a few such reasons. Therefore, the inclusion upon a product identifier of a product's quantity, or quantity options available for purchase, the benefits, drawbacks, or the manner in which this is done, is available for additional consideration by one skilled in the art. The faded or ghost like image 13 of the fish, which is intended to portray that of a product-related image, is located and can be viewed behind the key product identifying information 14a. The ability to place a logo, trademark or product-related image in this fashion aids in maintaining a product identifier relatively small in size while offering an additional aid to the consumer for future product identification purposes. When viewing FIG. 1A in its entirety, with the exception of the instructive insignia 12a, all of the indicia (indicia, intended to encompass all printed matter) in addition to the actual shape of the identifier presented, direct one toward future and specific product re-identification. The inclusion and duplication upon an identifier of its corresponding product's color scheme (not shown) tremendously enhance the product identifier, which contributes additional effectiveness to its intended use.

FIG. 1B illustrates the perspective back view of the product identifier displayed in FIG. 1A. A non-drying quick release type of adhesive application 11a performs that of a dual purpose, attachment of the identifier to its corresponding consumer product (FIG. 1C) along with offering reusable qualities to the consumer. The exclusion of adhesive 16, located directly behind the “Peel N Post” instructive insignia (12a seen illustrated in FIG. 1A) simplifies consumer removal of the product identifier from its corresponding consumer product (FIG. 1C).

FIG. 1C illustrates the corresponding consumer product to that of the identifier displayed in FIGS. 1A&B. It is not the intent of the inventors to imply or request a product's current label be altered to duplicate the appearance of its identifier. Therefore, when noting the faded or ghost like image 13 presentation similarities displayed upon the consumer product FIG. 1C, and that of the product identifier displayed in FIG. 1A, this similar method of presentation has been done for the purpose to offer additional clarification in the use of such method. An area where it is important to consider exact duplication, the product name, “Best Body Brand” 18a has been duplicated in font and manner of display when placed upon its product identifier (FIG. 1A). The placement 10a of the product identifier (illustrated in FIGS. 1A&B) upon its corresponding consumer product (FIG. 1C) can be seen located on the front and lower right-hand corner. Actual placement of a product identifier upon its corresponding consumer product is extremely flexible. In many situations an identifier may fit into that area currently set aside for a product's machine-readable code. This requires little or no need to alter or change a product's current label or its packaging for the inclusion of an identifier.

FIGS. 2A&B

The following description, combined with its corresponding drawings, illustrates the option to incorporate an embodiment into an already existing product label. Referring first to FIG. 2B, intended to simulate a common consumer product and its already existing product label, the embodiment can be seen placed 10b and incorporated into the front and lower portion of the illustration. The use of perforation 24 as an option to simplify the removal of an embodiment incorporated in this manner is also illustrated. The flexibility to place the instructive insignia 12b in a location other then on the actual embodiment is illustrated adjacent to its identifier displayed in FIG. 2B. “Farmers Best” 18b intended to be that of the product name, can be seen presented in identical font and manner upon its corresponding product identifier illustrated in FIG. 2A as that displayed upon the consumer product in FIG. 2B. The farmer pictured in both FIGS. 2A&B is intended to illustrate the product's trademark 17a.

Referring now to FIG. 2A, a perspective front view of the product identifier that corresponds to the consumer product illustrated in FIG. 2B. Illustrated here is an adhesive 11b option that would require a consumer to moisten the adhesive for the purpose to attach an identifier to a secondary surface. The inclusion of a machine readable product code 15 can be seen placed in a vertical position along the identifier's right-hand side. The key product identifying information 14b is illustrated in both the English and Spanish language. The use of two languages illustrates the ability to include a larger sector of the consumer market. By submitting the current disclosure in the English language and selecting the Spanish language to illustrate the inclusion of a secondary language, the intent is not to promote or show bias to any one language over that of another. The product name, “Farmers Best” 18b has not been converted or illustrated in a secondary language. Product brands and product names are often a language of their own, should there be a desire for translation, the option is available for one to do so. Additional key product identifying information 14b states that this specific product is the manufacturer's “extra sweet” variety of canned (not frozen) corn in the 11 ounce size and is lower in sodium then other versions of the product line available. The inclusion of information such as low sodium, cholesterol free, or contains shell fish, illustrates the ability to offer additional aid to those consumers that have medical conditions that need to be considered.

FIGS. 3A,B&C

FIGS. 3A&B display yet another embodiment that illustrates additional features available for incorporation into a product identifier. FIGS. 3A&B display an identifier that has been designed with an extended tab feature that creates additional ease in the removal of an identifier. It is upon this extended tab that the instructive insignia 12c, “Peel N Post”, has been placed (FIGS. 3A&C). The exclusion of adhesive 16, for even additional simplicity to remove an identifier from its corresponding consumer product (FIG. 3C), can be noted behind this tab like feature in FIG. 3B. Also illustrated in FIG. 3B is the option of placing additional indicia or information upon an identifier's back side prior to the application of adhesive 11a. The key product identifying information (14c displayed in FIG. 3A) has been translated into that of a secondary language (14d) and placed upon the identifier's back side (FIG. 3B) which accompanies the product name 18c, and the product related image 19a. This is only one example of many options available for the use of this area upon the back side a product identifier. Another usage example for this area may be the desire to promote other available or new products such as: “Try our new non-stick sterile wraps for larger injuries” (not shown). To avoid creating consumer confusion, or take away from the identifier's original purpose, caution is recommended to promote a product other then the one for which the identifier was intended. The key product identifying information 14c (FIG. 3A) informs the consumer that this specific product contains twenty (quantity) sheer and strong (physical description), latex free (allergy information), bandages (product type) in four different sizes (product size) with the added bonus of an antibiotic (consumer benefit or enticement). The picture of a bandage being applied to a finger (FIGS. 3A,B&C) illustrates the incorporation of a product use related image 19a into an identifier as a visual aid to further assist and simplify the product re-identification process. The identifier displayed in FIGS. 3A&B, and illustrated in placement 10c upon its corresponding consumer product in FIG. 3C, is basically in the shape of a square. An identifier in the shape of a bandage (not shown) would be attractive and offer even further assistance in future product identification.

FIGS. 4A&B

There are numerous circumstances that arise where it is desirable to view an actual product, its color, content, or content level within its container or packaging. These situations often require additional label creativity, especially if the product is small in size. FIGS. 4A&B illustrate a partially transparent embodiment capable of functioning in a dual manner, that of a future product identifier (as illustrated in FIG. 4A), and in placement 10d upon its corresponding consumer product (FIG. 4B) essentially comprising the product label. A non-transparent white background is commonly needed if including a Universal Product Bar Code as the product's machine-readable code 15. Therefore, the bar code in FIG. 4A can be seen placed within a box that is intended to illustrate its placement upon a non transparent area Continuing to refer to illustration FIG. 4A, accompanying the simulated product name 18d “Lovely Cosmetics” and trademark 17b (the double heart image) is the section that contains the product's key identifying information 14e. In this example embodiment the key product identifying information 14e starts with listing the product type “Liquid Eyeliner” in a somewhat bolder and larger font size then other product identifying information included. Including a product's type reduces the amount of time spent searching and re-identifying a specific product. The example product (FIG. 4B) intended for application close to the eye, information such as “Hypoallergenic” and “Smudge Proof” may be deemed as important qualitites by many of its users. It is common to see products that offer more then one color available for purchase, display both a general color description, “Dk. Brown”, and a more specific color code, “Color 2432”. The final product identifying information (14e) illustrated upon the product identifier (FIG. 4A) is that of the product's method of application, “Felt Tip”. Many consumer products are offered in more then one application type. Paint products are often sold in either a spray or brush method of application. Hair products are offered in both aerosol and pump type applicators. Some consumers prefer hand soap in bar form, while others prefer a liquid form. Should a product have more then one method of application, specifying the application type upon an identifier should be considered. The instructive insignia 12d (FIGS. 4A&B), “Peel N Post”, informs the consumer that the product label has been designed and attached with a type of adhesive (11a in FIG. 4A) that offers easy removal from the product with abilities to be posted for future product identification purposes.

FIGS. 5A through 5F

FIG. 5A illustrates a plan view and FIGS. 5B,C&D illustrate perspective views of an example embodiment for a future product identifier designed in a fold out manner, thus creating additional area for supplemental or product related information. FIGS. 5E&F illustrate environmental front and back views of the example embodiment's corresponding consumer product, an insect exterminator.

In FIGS. 5A,C&D, illustrations that display the example embodiment in its fully open configuration, the fold 23 location can be seen designated. For illustration and description simplification, the example embodiment displayed has been designed in a manner that has created panels simple and equal in size. While this example identifier is attractive and functional, a more creative identifier for this type of product could be designed in the shape of a house fly with wings that fold out (not shown) exposing product identifying and supplemental information. To refer again to the drawings, FIG. 5B illustrates the face or front perspective view of the product identifier in its fully folded and compact position. This face view is a duplicate to that displayed in the right panel illustrated in FIG. 5D. FIG. 5D displays FIG. 5B in a fully open configuration which illustrates the face panel upon the embodiment's right side and the back side of the final panel (or the back side of the right panel seen illustrated in FIG. 5C) upon the left side of the embodiment (in FIG. 5D). FIG. 5C also displays FIG. 5B in a fully open configuration. The identifier's interior panels are illustrated here. Although a product identifier is unique to its corresponding product, numerous options can be seen repeated and incorporated into the design of the example identifiers illustrated throughout the drawings. Therefore, other than to note the following options that have been included into the currently described identifier, any additional detail is deemed repetitive and unnecessary at this time. Once again note in the drawings the adhesive application 11a and the non adhesive area 16, along with the inclusion of the machine-readable code 15. The product name 18e, “Instant Insect Away” and product related images 19b (insects) have been incorporated into the identifier in numerous locations. The instructive insignia 12d can be seen placed in the upper left hand corner of the identifier's face panel illustrated in both FIGS. 5B&D. Numerous circumstances will place a product's identifier in low or non-visible locations. FIG. 5F displays the current identifier located and placed 10e upon the back side of its corresponding consumer product (FIG. 5F). Therefore, an example to inform consumers of the inclusion of the identifier can be seen upon the front of the corresponding product (12e in FIG. 5E). It is foreseeable that when a product's identifier becomes common consumer knowledge, the need to inform or obtain a consumer's attention in regards to its inclusion may not be necessary. To refer now to the left panel illustrated in FIG. 5C, displayed is the option to reenforce product precautions or warnings 22. Indicia (encompassing printed information) placed in this area is extremely flexible in content. There may be a preference to illustrate product usage or the desire to guarantee product satisfaction, or maybe the inclusion of a secondary language is of importance. For identifiers designed with more then one panel, it is suggested that the panel that bears adhesive be the panel holding the key and future product identifying information. By preparing an identifier in this manner, consumers have the option to remove and use or dispose the panels that are or are not of interest to them, this simplifies a somewhat complicated product identifier. Therefore, it is upon the right panel illustrated in FIG. 5C that all necessary elements needed for a consumer to identify the specific product for repurchase are incorporated. This right panel has the adhesive backing 11a, the product name 18e, use-related image(s) 19b, the machine readable product code 15, along with the product's key identifying information 14g. The key product identifying information 14g illustrated informs the consumer that this is the “Ready Mix” version of the product line, not the concentrated, mixing is not required, the method of application follows “Convenient Spray” (not the granule), this specific product within its line is used to extinguish “Ant, Tick, Grub & Many More Formula”, and finally the size is listed “Net Wt. 48 Oz.”. The product information 14f illustrated upon the face panel (in both FIGS. 5B&D) slants toward enticing a consumer while stating the product's effectiveness and areas of use. In the early stages of creating consumer awareness and the intended purpose of a product's identifier, the face panel may be used instead for reinforcing a consumer's usage of the identifier. A simple statement such as “Need to replenish me? I'm easy to find!” (not shown) encourage a consumer to repurchase the product along with simplifying the future identification process. A final inclusion illustrated in FIGS. 5A&C is that of the option to use a closure adhesive 25 for the purpose to temporarily maintain an identifier in its closed configuration until which time a consumer would like to view the identifier in its entirety.

FIGS. 6A through 6E

The ability of a future product identifier to take on numerous forms and serve multiple purposes can be seen illustrated once again in the example embodiment displayed in FIGS. 6A through D. FIG. 6A illustrates a plan view, while FIGS. 6B,C&D illustrate perspective views, of a simplified accordion or multi panel style embodiment which displays the option to create an identifier with even additional area. For illustration and description simplicity the example identifier displayed has been designed in a manner which results in three equal sized panels. In the following description these panels will be referred to as the left, center or right panel illustrated. The identifier illustrated (intended for baby diapers) is functional and attractive. Should there be a preference for a more creative identifier, one that takes on the appearance and is folded in a manner similar to a diaper (not shown) would be suitable and offer another element for future product recognition. FIG. 6E illustrates the environmental front view of the example embodiment's corresponding consumer product, a box of baby diapers. It is upon this illustration that the identifier's placement 10f can be noted.

In FIGS. 6A,C&D, illustrations that display the example embodiment in its fully open configuration, the fold 23 locations and closure adhesive 25 can be seen illustrated. FIG. 6B illustrates the face or front perspective view of the product identifier in a fully folded and compact position. It is upon this face panel that the instructive insignia 12d, “Peel N Post” has been placed. This front or face panel, is a duplicate of the left panel illustrated in FIG. 6C. FIG. 6C displays FIG. 6B in a fully open configuration. FIG. 6B is again illustrated in a fully open configuration in FIG. 6D. FIG. 6D displays the back or opposite side of the identifier. It is in this illustration (FIG. 6D) that the options to include a manufacturer's redeemable product coupon 21, four corners or a partial adhesive application 11c and the non-adhesive area 16 (for removal simplification) are displayed. An enclosure(s) other then a redeemable product coupon may be preferred, the inclusion of braille, a secondary language(s), or a consumer questionnaire, name only a few such other options available for consideration. The inclusion of the product's machine readable code 15 can be see located in the right panel illustrated in both the plan view, FIG. 6A, and the identifier's perspective view in FIG. 6C. Throughout FIGS. 6B,C&D, and displayed in a manner identical to that upon the original product (FIG. 6E, simulated for illustration purposes), the repeated use of the product's trademark 17c, a round smiley face, and product name 18f “Smiley Baby Diapers”, can be noted.

Referring now to FIG. 6C, the face or left panel illustrates the option to inform consumers of an additional enclosure 20a upon the embodiment's reverse side. The enclosure referred to is that of the redeemable product coupon (21 in FIG. 6D) previously discussed. The central panel repeats this informational disclosure 20b in a secondary language. The key product identifying information 14h illustrated in both the left and right panels is identical and repeated again upon the central panel in a secondary language (14i). Note that the necessary elements for future product recognition have been placed upon the right panel, or the panel bearing the adhesive 11c application. This intentional method of placement allows those consumers not interested in the additional enclosure (21 in FIG. 6D), or in need of a secondary language (the center panel in FIG. 6C), to remove and discard those sections, which reduces and simplifies both the product identifier and its eventual use or placement upon a secondary surface such as a shopping list.

Although the present invention has been described in detail with multiple example embodiments, those skilled in the art will understand that various changes, substitutions, and alterations herein may be made without departing from the spirit and scope of the invention in its broadest form. Therefore, the foregoing embodiments are to be considered, in all respects, illustrative rather then limiting on the invention described herein. Scope of the invention is thus indicated by the appended claims rather than by the foregoing description, and all changes that come within the meaning and range of equivalency of the claims are intended to be embraced therein.

1.-36. (canceled)

37. A consumer product recognition system including:
a consumer product;
a product label affixed to the consumer product; and
an identifier having a predetermined shape and removably affixed to the product label, the identifier including
a first front surface, and
a second back surface, wherein the second back surface includes an adhesive for attaching the identifier to a remote secondary receiving surface which is not the product label, after the identifier is removed from the product label;
wherein the first front surface includes indicia having identifying information and supplemental information.

38. The consumer product recognition system according to claim 37, wherein the first front surface further includes machine readable code.

39. The consumer product recognition system according to claim 37, wherein the shape of the identifier corresponds to a shape of the consumer product.

40. The consumer product recognition system according to claim 37, wherein the consumer product contains a plurality of items and wherein the shape of the identifier corresponds to a shape of at least one item.

41. The consumer product recognition system according to claim 37, wherein the first front surface is a surface of the product label.

42. The consumer product recognition system according to claim 37, wherein the identifier is at least partially transparent.

43. The consumer product recognition system according to claim 37, wherein the identifier is at least partially opaque.

44. The consumer product recognition system according to claim 37, wherein the identifier further includes an extended tab, wherein the extended tab is detached from the product label.

45. The consumer product recognition system according to claim 37, wherein the identifying information includes an illustration associated with the consumer product.

46. The consumer product recognition system according to claim 45, wherein the illustration includes at least one of: a watermark, a predetermined color scheme, and a representation of content associated with the consumer product.

47. The consumer product recognition system according to claim 37, wherein the supplemental information includes at least one of: consumer instruction, promotion, incentive, health information, and safety disclosure.

48. The consumer product recognition system according to claim 47, wherein the identifying information and the supplemental information are provided in at least two different languages.

49. The consumer product recognition system according to claim 48, wherein at least one of the languages is written using the Braille system.

50. The consumer product recognition system according to claim 37, wherein the identifier further includes a plurality of panels, wherein the panels are separated by at least one of: perforations, printed lines, and fold lines on at least one of the first front surface and second back surface.

51. The consumer product recognition system according to claim 50, wherein the identifier further includes means for selectively closing the plurality of panels.

52. (canceled)

53. The consumer product recognition system according to claim 37, wherein the second back surface further includes the identifying information and supplemental information in at least one secondary language.

54. A consumer product identifier for a consumer product, the consumer product identifier having a predetermined shape and removably affixed to a product label, the identifier comprising:
a first front surface, and
a second back surface, wherein the second back surface further includes an adhesive for attaching the identifier to a remote secondary receiving surface which is not the product label, after the identifier is removed from the product label;
wherein the first front surface includes indicia having identifying information and supplemental information.

55. The identifier according to claim 54, wherein the first front surface further includes machine readable code.

56. The identifier according to claim 54, wherein the shape of the identifier corresponds to a shape of the consumer product.

57. The identifier according to claim 54, wherein the consumer product contains a plurality of items and wherein the shape of the identifier corresponds to a shape of at least one item.

58. The identifier according to claim 54, wherein the first front surface is a surface of the product label.

59. The identifier according to claim 54, wherein the identifier is at least partially transparent.

60. The identifier according to claim 54, wherein the identifier is at least partially opaque.

61. The identifier according to claim 54, wherein the identifier further includes an extended tab, wherein the extended tab is detached from the product label.

62. The identifier according to claim 54, wherein the identifying information includes an illustration associated with the consumer product.

63. The identifier according to claim 62, wherein the illustration includes at least one of: a watermark, a predetermined color scheme, and a representation of content associated with the consumer product.

64. The identifier according to claim 54, wherein the supplemental information includes at least one of: consumer instruction, promotion, incentive, health information, and safety disclosure.

65. The identifier according to claim 64, wherein the identifying information and the supplemental information are provided in at least two different languages.

66. The identifier according to claim 65, wherein at least one of the languages is written using the Braille system.

67. The identifier according to claim 54, wherein the identifier further includes a plurality of panels, wherein the panels are separated by at least one of: perforations, printed lines, and fold lines on at least one of the first front surface and second back surface.

68. The identifier according to claim 67, wherein the identifier further includes means for selectively closing the plurality of panels.

69. (canceled)

70. The identifier according to claim 54, wherein the second back surface further includes the identifying information and supplemental information in at least one secondary language.

71. A consumer product identifier for attachment to a consumer product or a consumer product label affixed to the consumer product, wherein the consumer product identifier has a predetermined shape and is removably affixed to the consumer product or the product label, and wherein the consumer product identifier comprises:
a first front surface, wherein the first front surface includes indicia having identifying information and supplemental information, and
a second back surface, wherein the second back surface includes an adhesive for attaching the consumer product identifier to a remote secondary receiving surface which is not the consumer product or the consumer product label, after the consumer product identifier is removed from the consumer product or the product label.

72. The consumer product identifier according to claim 71, wherein the shape of the consumer product identifier corresponds to a shape of the consumer product.

73. The consumer product identifier according to claim 71, wherein the consumer product contains a plurality of items and wherein the shape of the consumer product identifier corresponds to a shape of at least one item.
